(19) United States
(12) Patent Application Publication
(10) Pub. No.: US 2017/0361529 A1
(43) Pub. Date: Dec. 21, 2017

(54) APPARATUS AND METHOD FOR PRODUCTION OF THREE-DIMENSIONAL OBJECTS

(71) Applicant: Atomics Monkey Products Limited, Fo Tan New Territories (CN)

(72) Inventor: Wei Kong Wilson MAK, Hong Kong (CN)

(21) Appl. No.: 15/324,290

(22) PCT Filed: Mar. 10, 2016
(86) PCT No.: PCT/IB2016/051355

§ 371 Date: Jan. 6, 2017

(30) Foreign Application Priority Data
Mar. 12, 2015 (AU) 2015900895

(51) Int. Cl. B29C 64/129; B33Y 30/00; B29C 64/277; B33Y 10/00

(52) U.S. Cl. CPC B29C 64/129; B29C 64/277; B33Y 30/00; B33Y 10/00

(57) ABSTRACT

An apparatus and method for production of three-dimensional objects are disclosed. The apparatus comprises a reflective chamber (10), a plurality of electromagnetic radiation sources (35) adapted for providing electromagnetic radiation inside the reflective chamber (10), the plurality of electromagnetic radiation sources (35) mounted on inner walls of the reflective chamber (10). The method comprises the steps of placing a UV material on a model template or a transparent plate (51,52), setting of time value and light intensity of ultra violet light emitted from a plurality of electromagnetic radiation sources (35) and allowing the reflection of ultra violet light between a plurality of reflective layers inside the reflective chamber (10), solidifying the material inside the reflective chamber (10) after a period of time set out by control means and forming a three-dimensional object from the UV activated material on a model template or transparent plate (51,52).

### TECHNICAL FIELD

The present invention relates broadly to an apparatus and method for production of an object. More specifically, the invention relates to an apparatus and method for applying electromagnetic radiation on a liquid or a flexible material to produce solid three-dimensional objects.

### BACKGROUND OF THE INVENTION

The recent development of three-dimensional model making machines is very fast in these few years. Customers have many choices on choosing various kinds of three-dimensional model making machine in the market. Ultra-violent light solidification box is one of their choice. Such UV box is able to solidify the UV activated material which is either in liquid form or solid form. However, the problem faced by the user is that the time to complete the whole solidification process for modelling by such UV box is very long. In addition, the UV light for solidification is not so even distributed inside the UV box. The result is that certain weak performances including uneven hardness and lack of durability are often appeared in such three-dimensional model making machines of the existing technology.

### SUMMARY OF THE INVENTION

The problem to be solved in the present invention is to solve the technical problem of the uneven hardness of three-dimensional objects made by three-dimensional objects making machine of the existing technology and this problem will result in less durability and structural weakness of the objects. Another problem to be solved in the present invention is to provide an apparatus and method for making durable three-dimensional objects effectively.

The present invention provides an apparatus for production of three-dimensional objects comprising a reflective chamber, a plurality of electromagnetic radiation sources adapted for providing electromagnetic radiation inside the said reflective chamber, the plurality of electromagnetic radiation sources arranged on inner walls of the said reflective chamber, a reflective layer for reflecting the said electromagnetic radiation provided by the said electromagnetic radiation sources mounted on an inner wall of the said reflective chamber, a three-dimensional object receiver removably mounted inside the said reflective chamber, a switching means for controlling the power of the said apparatus mounted to the said apparatus and a control means for controlling the operation of the plurality of the said electromagnetic radiation sources mounted to the said apparatus.

Typically, a flexible member is received by the said three-dimensional object receiver.

Typically, the said flexible member is adapted to be solidified by the said electromagnetic radiation from the plurality of the said electromagnetic radiation sources.

Typically, the said flexible member is made of a UV activated material.

Typically, the said UV activated material comprises 600 to 900 parts by weight of a Polycarbonate diol and 1 to 20 parts by weight of UV Colorants.

Typically, the said UV activated material further comprises 50 to 300 parts by weight of a Dipentaerythritol Hexaacrylate.

Typically, the said UV activated material further comprises 10 to 100 parts by weight of a silicon dioxide.

Typically, the said UV activated material further comprises 10 to 100 parts by weight of a Photoinitiator 184.

Typically, the said reflective substance adapted for reflecting the light from the plurality of the said electromagnetic radiation sources inside the said reflective chamber is made of aluminum.

Typically, the said reflective substance is aluminum coating mounted on the inner walls of the said reflective chamber.

Typically, a reflective chamber cover adapted for preventing the said electromagnetic radiation escaping from the said reflective chamber is pivotally mounted to the said reflective chamber.

Typically, wherein the said reflective chamber cover comprises a reflective layer adapted for reflecting the said electromagnetic radiation from electromagnetic radiation sources arranged on a side facing the inner walls of the said reflective chamber.

Typically, the said control means is adapted to control the time value and light intensity of emission of electromagnetic radiation provided by the said electromagnetic radiation sources.

Typically, the said electromagnetic radiation sources is formed by ultra-violet light-emitting diodes

Typically, the said three-dimensional object receiver is a transparent plate.

Typically, the said three-dimensional object receiver comprises a plurality of concave regions adapted for receiving the said UV activated material.

Typically, the said three-dimensional object receiver comprises a plurality of convex elements adapted to be covered by the said UV activated material.

Typically, the said reflective chamber is formed by a combination of two U-shaped structures.

Typically, the said UV activated material comprises at least one of of Polycarbonate diol, Acryloylmorpholine, silicon dioxide, Dipentaeythritol Hexaacrylate, 2,4,6-Trimethyl Benzoyl Diphenyl Phosphine Oxide, Photoinitiator 184 and UV colorants.

Typically, at least two concave members for receiving the end portions of the said three-dimensional object receiver are arranged on opposing inner walls of the said reflective chamber.

The present invention further provide a method for production of three-dimensional objects comprising the steps of placing a UV activated material on a model template or transparent plate; setting of time value and light intensity of ultra violet light emitted from a plurality of electromagnetic radiation sources by a control means for controlling the operation of the plurality of the said electromagnetic radiation sources; emitting ultra violet light from the plurality of the said electromagnetic radiation sources and allowing the reflection of ultra violet light between a plurality of reflective layers inside the reflective chamber; solidifying the said UV activated material inside the said reflective chamber after a period of time set out by the said control means; forming a three-dimensional object from the said UV activated material on a model template or transparent plate.

Typically, the said UV activated material comprises at least one of Polycarbonate diol, Acryloylmorpholine, silicon dioxide, Dipentaeythritol Hexaacrylate, 2,4,6-Trimethyl Benzoyl Diphenyl Phosphine Oxide, Photoinitiator 184 and UV colorants.

Typically, the said time value is between 60 seconds and 300 seconds.

### BRIEF DESCRIPTION OF DRAWINGS

This and other objects, features and advantages of the present invention will become apparent upon reading of the following detailed descriptions and drawings, in which:

FIG. 1 shows a perspective view of an embodiment of the present invention;

FIG. 2 shows an exploded view of the embodiment of the present invention;

FIG. 3 shows a perspective view of another embodiment of the present invention; and

FIG. 4 shows a perspective view of a receiver for storing the flexible member of the present invention.

### DESCRIPTION OF EMBODIMENTS

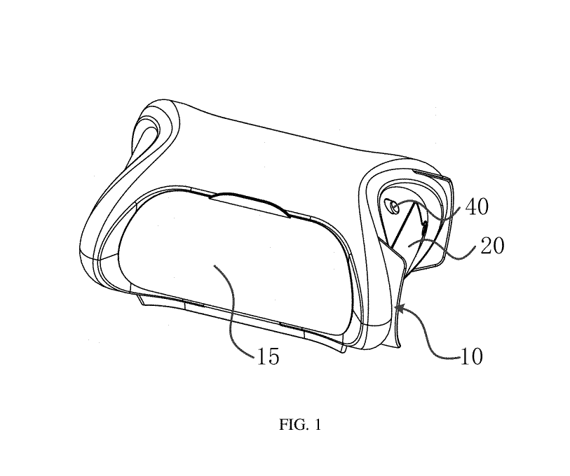

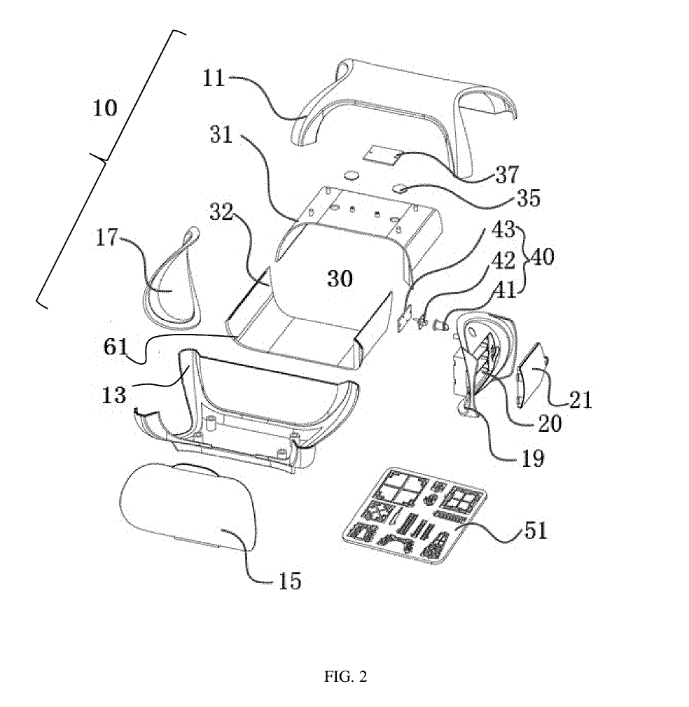

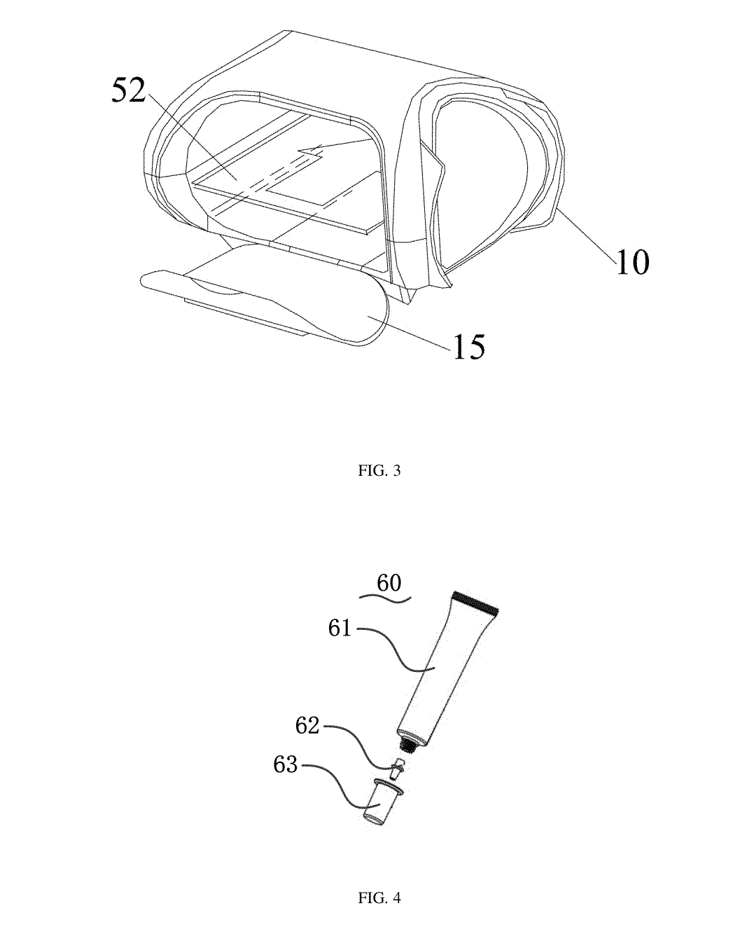

Referring to FIG. 1, FIG. 2, FIG. 3 and FIG. 4, in an embodiment of the present invention, an apparatus for production of three-dimensional objects is constructed in the present invention, a reflective chamber 10 comprises a reflective layer. The reflective layers are mounted on the inner walls of the reflective chamber 10. Preferably, the reflective layer is an aluminum coating coated on the inner walls of the reflective chamber 10. Alternatively, other materials having high reflective characteristics for reflecting ultra violet light can also be used as a reflective layer. Additionally, the reflective layer can incorporate an electromagnetic radiation source or specific optical focused ultra-violent light light-emitting diodes or UV LEDs. The reflective layers are preferred to be arranged on all inner walls of the reflective chamber in order that the UV light can be reflected by all surfaces inside the reflective chamber 10 and allow at least one light reflection from at least one inner wall to the flexible member or UV activated material. The above construction facilitates an evenly, uniformly and optimum light distribution across inner walls of the reflective chamber 10, and shortens the curing time for the flexible member or UV activated material such as resin and plastic materials. The UV activated materials will be solidified to become a three-dimensional object within the prescribed time. It uses less power consumption and no heat is generated during operation. In the embodiment, the apparatus can apply electromagnetic radiation on a flexible material or a liquid substance or UV activated material in order to produce solid three-dimensional objects by constructing the reflective chamber 10 made of aluminum or other metals or other materials with reflective surface as a reflection media/material for UV light as its interior structure. Additionally, the UV LED or electromagnetic radiation can be as a light source which can be arranged inside the reflective chamber 10. In this embodiment, alternatively, the reflective chamber 10 can further comprises a hollow portion 30. The hollow portion 30 is adapted to receive the flexible material or UV activated material which is to be solidified inside the reflective chamber 10. The hollow portion 30 can be defined between two opposing inner walls of the reflective chamber 10. Further, the hollow portion 30 can be surrounded by at least two walls coated with reflective layers. An opening for being a passage allowing the three-dimensional object receiver 51 or 52 to be placed inside the hollow portion 30 is arranged on an end of the hollow portion 30. Preferably, the three-dimensional object receiver 51 or 52 is removably mounted to the opposing walls of the hollow portion 30 or opposing inner walls of the reflective chamber 10. It is also preferred that concave members 61 or concave slideways 61 for receiving and supporting the end portions of the three-dimensional object receiver 51 or 52 are arranged on the walls of the hollow portion 30 or the inner walls of the reflective chamber 10.

In this embodiment, alternatively, the hollow portion 30 can also be a hollow cylindrical structure having at least one opening mounted inside the reflective chamber 10. The inner walls of the hollow portion 30 are coated with reflective layers, such as aluminum films. Preferably, in order to provide an enclosed chamber with high reflective condition for solidification process, the inner walls of the remaining portion of the reflective chamber 10 facing the three-dimensional object receiver 51 or 52 can be coated with reflective layers or aluminum films. Typically, UV activated material or flexible material can be received inside a hollow portion 30 of the reflective chamber 10. By considering that the outer shell of the reflective chamber 10 can be made of plastic in order to reduce the total weight of the apparatus, the hollow cylindrical structure of the hollow portion 30 can be made of metal in order to increase the performance of light reflection inside the hollow portion 30. The present invention chooses a light metal, such as aluminum, to construct the hollow portion 30. The advantage of using aluminum as a material of the hollow portion is that the performance of light reflection of solid aluminum is comparatively higher than aluminum coatings or films. Alternatively, the hollow portion 30 can also be made of plastic material with aluminum coatings. Preferably, the hollow portion 30 of the reflective chamber 10 comprises a plurality of inner walls which can be coated with reflective material adapted for light reflection. Alternatively, the inner walls can be made of aluminum or other metals having reflective layer or reflective surface. In the embodiment, it is preferable to apply the aluminum coatings or aluminum material or aluminum film on the hollow portion because the aluminum has a characteristic of high reflective index which can maximize the reflection of electromagnetic radiation including the ultraviolet light onto the UV activated material including liquid substance or flexible material. Preferably, a plurality of electromagnetic radiation sources 35 or UV LEDs 35 can be arranged on the inner walls of the reflective chamber 10 or UV Chamber or the hollow portion 30. Alternatively, UV LEDs 35 can be mounted on at least one inner wall of the hollow portion and they can be evenly distributed and mounted on all inner walls of the hollow portion. Preferably, by considering the safety reason, the present invention chooses to use UV LEDs instead of traditional UV lamps as a light source because UV lamp is made of glass which is very dangerous for children use.

In the embodiment, the reflective chamber 10 can comprise an outer shell formed by an upper member 11, a bottom member 13, a first side member 17 and a second side member 19. Particularly, a hollow structure having side walls and an opening can be formed by the combination of the upper member 11 and the bottom member 13. A reflective chamber cover 15 is removably or pivotally mounted to the opening of the hollow structure. The hollow structure can be the hollow portion 30. The reflective chamber cover 15 can function as a door to cover the opening in order for allowing the hollow portion to become an enclosed region and preventing the electromagnetic radiation or UV light escaping from the reflective chamber 10. As such, the construction can restrict the UV light to be reflected within the chamber only. Additionally, the reflective chamber cover 15 can have a side surface which is coated with a reflective layer facing towards the hollow portion 30 in order to provide additional reflective means to maximum light reflections inside the reflective chamber 10. The above reflective layer can be a metal reflective film or an aluminum film having a reflective index. Alternatively, the reflective chamber cover 15 can be pivotally mounted to the upper member 11 or the bottom member 13.

In the embodiment, the battery receiver 20 for receiving the battery can be arranged in the first side member 17 or the second side member 19. Preferably, the battery receiver 20 can be the concave region of the first side member 17 or the second side member 19. A space from the outer wall of the first side member 17 or the second side member 19 towards the interior portion of the reflective chamber 10 forms the concave region which defines the battery receiver 20. Further, a battery cover 21 can cover the opening of the battery receiver 30 through buckles or other means.

Preferably, the hollow portion 30 can be constructed by combination of an upper structure 31 and a lower structure 32. A plurality of electromagnetic radiation sources or UV LEDs 35 can be mounted on the upper structure 31 or the lower structure 32 or both.

Additionally, a switch assembly or switching means 40 for controlling the power of the apparatus includes a switch 41, a switch connector 42 and a switch printed circuit board 43. The switch connector 42 adapted for providing ON/ OFF signal to the switch printed circuit board 43 is arranged between the switch 41 and the switch printed circuit board 43. A control means 37 for controlling the UV LEDs or electromagnetic radiation sources 35 is connected with the switching means 40 and the battery receiver 20. The battery receiver 20 is adapted to provide power to both switching means 40 and control means 37 to operate. Further, the control means 37 is adapted to control the time value and light intensity of emission of electromagnetic radiation or ultra-violent light provided by the said electromagnetic radiation sources or UV LEDs 35. Also, the control means 37 can control and manage the processing time of the solidification of the apparatus. Particularly, the user can depend on the kind of model or materials to be solidified inside the reflective chamber and allow the control means to control the completion time of the whole solidification process or re-solidification process. Alternatively, the user can follow the instruction of the suggested time for solidification of a particular UV activated material and input the time data and light intensity data to the control means 37 in order to control the desired hardness of the three-dimensional objects during model making process.

Referring to FIG. 4, the flexible member or the UV activated material can be stored in a container or receiver.

Referring to FIG. 1 and FIG. 2, in the embodiment, a three-dimensional object receiver 51 or model template or model plate is adapted for carrying the flexible member or UV activated materials inside the reflective chamber 10.

In this embodiment, a three-dimensional object receiver or the model template 51 is a mold plate having a plurality of separate parts of a complete model which are allowed to put the UV activated material into a plurality of concave regions of the model template 51. Alternatively, a convex element can also be arranged on the model template 51 or the three-dimensional object receiver 51 in order that the UV activated material can cover the convex element. Particularly, a plurality of convex elements is adapted to be projected from a side of the model template 51 or the three-dimensional object receiver 51 and the outer surfaces of the convex elements are able to be covered or surrounded by the the UV activated material. More particularly, the convex element can be a mold with a variety of shapes. Alternatively, the convex element can also be arranged on the concave region of the model template 51 or the three-dimensional object receiver 51. In this embodiment, the UV activated material or the flexible member which is covering the convex element can form a hollow convex structure or pre-determined structure after solidification process. After the completion of the solidification process performed inside the reflective chamber 10, such UV activated materials being placed inside the concave regions or on the convex elements will become solid three-dimensional parts of the complete model. The user can make a complete model by mounting the parts together. Preferably, the different patterns of the model template 51 are designed to make different models. Alternatively, other carriers can be used as a model base for carrying the UV activated materials in order for the user to design his own model by using different shapes or patterns or appearance of the model base.

Referring to FIG. 3, in another embodiment, the three-dimensional object receiver can be a transparent plate 52 adapted for receiving the UV activated material is mounted in the central part of the hollow portion 30. The transparent plate 52 is used to allow the UV light to pass through and reach the UV activated material during solidification process. In this embodiment, the processing time to complete the solidification of the UV activated material inside the reflective chamber 10 will be greatly reduced because the UV light rays will be increased by reflections through the reflective surfaces of the inner walls of the hollow portion 30 such that almost all parts of the UV activated materials will be reached by UV light rays in a short period of time.

In this embodiment, the user can put solid three-dimensional object together with the UV activated materials into the reflective chamber 10 in order to perform re-solidification process. The re-solidification process is adapted to make a top-up solidification based on the existing three-dimensional objects. The re-construction of a basic three-dimensional object by solidification process through implementation of the present invention can be used as modelling or production of the parts of a complete model.

In the present invention, the solidification process involves the UV activated material, which can be a specially formulated resin/ink that can be drawn in any shape the user chooses onto a non-stick surface as provided. The user inserts the non-stick template made of UV activated material into the reflective chamber 10, closes the hinged door or the reflective chamber cover 15 and activates the UV LEDs through the control means. Alternatively, the user can input the different programs of the control means in order to choose the preferred processing time and light intensity. It further prevents the leaking of UV light rays from the apparatus by closing the hinged door and cause harmful effect to the children users. The UV activated material will be hardened or solidified within the prescribed time (preferably in between 60 seconds and 300 seconds) so that it is hard enough to use as a craft toy construction piece. Posts, Walls and frames can be created this way and used to form bigger structures.

The present invention provides a method for production of three-dimensional objects. In this embodiment, the user can place a UV activated material on a model template 51 or a transparent plate 52. Particularly, the user can place the UV activated material into at least one concave region with at least one default shape of the model template 51. Alternatively, in case of re-solidification process, the user can put the UV activated material with a pre-determined shape on the transparent plate 52. After activation of the control means 37 and the switching means 40, the electromagnetic radiation sources will emit the ultra violet light inside the reflective chamber 10. The ultra violet light is then reflected onto the surfaces of the said UV activated material between a plurality of reflective layers inside the reflective chamber 10. The setting of time value and light intensity of ultra violet light emitted from the electromagnetic radiation sources is determined and controlled by the control means. After a period of time set out by the control means or a period of the time value, the UV activated material inside the reflective chamber 10 is solidified. Then, the model template 51 or transparent plate 52 can be removed from the reflective chamber 10. Further, the UV activated material forms a three-dimensional object on a model template or transparent plate. Alternatively, the three-dimensional object with the pre-determined shape of the concave region or convex element can be formed. The above three-dimensional object can be a part of the model in the model template 51 such that the whole model will be created by combination of the parts of the model in the model template 51. Alternatively, the method for production of three-dimensional objects can comprises steps of placing a UV activated material on a model template or transparent plate; setting of time value and light intensity of ultra violet light emitted from a plurality of electromagnetic radiation sources by a control means for controlling the operation of the plurality of the said electromagnetic radiation sources; emitting ultra violet light from the plurality of the said electromagnetic radiation sources and allowing the reflection of ultra violet light between a plurality of reflective layers inside the reflective chamber; solidifying the said UV activated material inside the said reflective chamber after a period of time set out by the said control means and forming a three-dimensional object from the said UV activated material on a model template or transparent plate.

In the above embodiments, the UV activated material can comprise Polycarbonate diol, Acryloylmorpholine, silicon dioxide, Dipentaeythritol Hexaacrylate, 2,4,6-Trimethyl Benzoyl Diphenyl Phosphine Oxide, Photoinitiator 184 and UV colorants. Alternatively, in respect of the use of a safety modelling apparatus for children use of the present invention, the UV activated material preferably comprises Acryloylmorpholine, silicon dioxide, Dipentaeythritol Hexaacrylate and Photoinitiator 184. Alternatively, the UV activated material comprises Acryloylmorpholine, silicon dioxide and Dipentaeythritol Hexaacrylate. Alternatively, the UV activated material comprises silicon dioxide and Acryloylmorpholine.

Preferably, in order to implement the above embodiments of the present invention and by considering the safety of children in using the apparatus, the composition of the flexible member or the UV activated material is required to get rid of long-term health hazards. Through numerous experiments, preferably, the composition of UV activated material for children use comprises 71% to 75% parts by weight of Polycarbonate diol, 17% to 20% parts by weight of Dipentaerythritol Hexaacrylate, 6% to 8% parts by weight of Silicon Dioxide, 3% to 4% parts by weight of Photoinitiator 184 and 0.8% parts by weight of UV Colorants. Alternatively, the composition of the composition of the flexible member or the UV activated material can comprise 600 to 900 parts by weight of a Polycarbonate diol, 1 to 20 parts by weight of UV Colorants, 50 to 300 parts by weight of a Dipentaerythritol Hexaacrylate, 10 to 100 parts by weight of a silicon dioxide and 10 to 100 parts by weight of a Photoinitiator 184. In particular, by using the UV activated material with the above composition by children and through observation of numerous experiments, there is no significant sign or symptoms indicative of any adverse health hazard are expected to occur at standard conditions due to the low volatility of this material.

The present invention has been described in detail, with reference to the preferred embodiment, in order to enable the reader to practice the invention without undue experimentation. However, a person having ordinary skill in the art will readily recognize that many of the previous disclosures may be varied or modified somewhat without departing from the spirit and scope of the invention. Accordingly, the intellectual property rights to this invention are defined only by the following claims.

1. An apparatus for production of three-dimensional objects comprising:
a reflective chamber;
a plurality of electromagnetic radiation sources adapted for providing electromagnetic radiation inside the said reflective chamber;
the plurality of electromagnetic radiation sources arranged on inner walls of the said reflective chamber;
a reflective layer for reflecting the said electromagnetic radiation provided by the said electromagnetic radiation sources mounted on an inner wall of the said reflective chamber;
a three-dimensional object receiver removably mounted inside the said reflective chamber;
a switching means for controlling the power of the said apparatus mounted to the said apparatus; and
a control means for controlling the operation of the plurality of the said electromagnetic radiation sources mounted to the said apparatus.

2. The apparatus for production of three-dimensional objects according to claim 1, a flexible member is received by the said three-dimensional object receiver.

3. The apparatus for production of three-dimensional objects according to claim 2, the said flexible member is adapted to be solidified by the said electromagnetic radiation from the plurality of the said electromagnetic radiation sources.

4. The apparatus for production of three-dimensional objects according to claim 3, wherein the said flexible member is made of a UV activated material.

5. The apparatus for production of three-dimensional objects according to claim 4, wherein the said UV activated material comprises 600 to 900 parts by weight of a Polycarbonate diol and 1 to 20 parts by weight of UV Colorants.

6. The apparatus for production of three-dimensional objects according to claim 5, wherein the said UV activated material further comprises 50 to 300 parts by weight of a Dipentaerythritol Hexaacrylate.

7. The apparatus for production of three-dimensional objects according to claim 6, wherein the said UV activated material further comprises 10 to 100 parts by weight of a silicon dioxide.

8. The apparatus for production of three-dimensional objects according to claim 7, wherein the said UV activated material further comprises 10 to 100 parts by weight of a Photoinitiator 184.

9. The apparatus for production of three-dimensional objects according to claim 1, wherein the said reflective substance adapted for reflecting the light from the plurality of the said electromagnetic radiation sources inside the said reflective chamber is made of aluminum.

10. The apparatus for production of three-dimensional objects according to claim 7, wherein the said reflective substance is aluminum coating mounted on the inner walls of the said reflective chamber.

11. The apparatus for production of three-dimensional objects according to claim 1, wherein a reflective chamber cover adapted for preventing the said electromagnetic radiation escaping from the said reflective chamber is pivotally mounted to the said reflective chamber.

12. The apparatus for production of three-dimensional objects according to claim 11, wherein the said reflective chamber cover comprises a reflective layer adapted for reflecting the said electromagnetic radiation from electromagnetic radiation sources arranged on a side facing the inner walls of the said reflective chamber.

13. The apparatus for production of three-dimensional objects according to claim 1, wherein the said control means is adapted to control the time value and light intensity of emission of electromagnetic radiation provided by the said electromagnetic radiation sources.

14. The apparatus for production of three-dimensional objects according to claim 14, wherein the said electromagnetic radiation sources is formed by ultra-violet light-emitting diodes

15. The apparatus for production of three-dimensional objects according to claim 1, wherein the said three-dimensional object receiver is a transparent plate.

16. The apparatus for production of three-dimensional objects according to claim 4, wherein the said three-dimensional object receiver comprises a plurality of concave regions adapted for receiving the said UV activated material.

17. The apparatus for production of three-dimensional objects according to claim 4, wherein the said three-dimensional object receiver comprises a plurality of convex elements adapted to be covered by the said UV activated material.

18. The apparatus for production of three-dimensional objects according to Claiml, wherein the said reflective chamber is formed by a combination of two U-shaped structures.

19. The apparatus for production of three-dimensional objects according to claim 4, wherein the said UV activated material comprises at least one of of Polycarbonate diol, Acryloylmorpholine, silicon dioxide, Dipentaeythritol Hexaacrylate, 2,4,6-Trimethyl Benzoyl Diphenyl Phosphine Oxide, Photoinitiator 184 and UV colorants.

20. The apparatus for production of three-dimensional objects according to claim 4, wherein at least two concave members for receiving the end portions of the said three-dimensional object receiver are arranged on opposing inner walls of the said reflective chamber.

21. A method for production of three-dimensional objects comprising the steps of:
placing a UV activated material on a model template or transparent plate;
setting of time value and light intensity of ultra violet light emitted from a plurality of electromagnetic radiation sources by a control means for controlling the operation of the plurality of the said electromagnetic radiation sources;
emitting ultra violet light from the plurality of the said electromagnetic radiation sources and allowing the reflection of ultra violet light between a plurality of reflective layers inside the reflective chamber;
solidifying the said UV activated material inside the said reflective chamber after a period of time set out by the said control means;
forming a three-dimensional object from the said UV activated material on a model template or transparent plate.

22. A method for production of three-dimensional objects according to claim 21, wherein the said UV activated material comprises at least one of Polycarbonate diol, Acryloylmorpholine, silicon dioxide, Dipentaeythritol Hexaacrylate, 2,4,6-Trimethyl Benzoyl Diphenyl Phosphine Oxide, Photoinitiator 184 and UV colorants.

23. A method for production of three-dimensional objects according to claim 21, wherein the said time value is between 60 seconds and 300 seconds.
